(19) United States
(12) Patent Application Publication
(10) Pub. No.: US 2011/0263362 A1
(43) Pub. Date: Oct. 27, 2011

(54) Hydraulic arrangement for controlling a transmission

(75) Inventors: Marco Grethel, Buhlertal (DE); Eric Müller, Kaiserslautern (DE)

(73) Assignee: Schaeffler Technologies GmbH & Co. KG, Herzogenaurach (DE)

(21) Appl. No.: 13/066,452

(22) Filed: Apr. 14, 2011

(30) Foreign Application Priority Data
Oct. 16, 2008 (DE) DE 102008051967.7
Sep. 21, 2009 (DE) PCT/DE2009/001327

(51) Int. Cl. F16H 61/662; F15B 1/02

(52) U.S. Cl. 474/28; 60/413

(57) ABSTRACT

A hydraulic arrangement for controlling a transmission connected downstream of an internal combustion engine having a start-stop device. A hydraulic energy source provides hydraulic energy, an energy accumulator is connected downstream of the hydraulic energy source for storing and dispensing hydraulic energy provided by the hydraulic energy source, and a hydraulic controller is associated with the hydraulic energy source and the energy accumulator for controlling the transmission. The energy accumulator is associated with the hydraulic controller by a branch line to a pilot control circuit.

### BACKGROUND OF THE INVENTION

1. Field of the Invention

The present invention relates to a hydraulic arrangement for the control of an internal combustion engine with a transmission connected downstream of a start-stop-device, with a hydraulic energy source for providing hydraulic energy, an energy accumulator connected downstream of the hydraulic energy source for at least partial storing and dispensing of the hydraulic energy that can be made ready by means of the hydraulic energy source, and a hydraulic control for the automated transmission associated with the hydraulic energy source and energy accumulator.

2. Description of the Related Art

Hydraulic arrangements of the type mentioned from the outset are well known. The internal combustion engine can be started and stopped by means of the start-stop-device, for example dependent on predefined operating states of a motor vehicle capable of being driven by means of the internal combustion engine. By means of the energy accumulator, the hydraulic control can be supplied additionally with hydraulic energy for controlling the automated transmission, especially during a stop phase of the internal combustion engine.

DE 43 23 133 A1 discloses a hydraulic accumulator for providing pressure fluid. EP 1 898 101 A2 relates to a method of actuating a hydraulic accumulator device of a transmission device.

It is an object of the present invention to provide an improved hydraulic arrangement for the control of an internal combustion engine with a transmission connected downstream of a start-stop-device. The hydraulic arrangement should be optimized especially with regard to the necessary space, a possibly high temperature, and/or aging stability.

### SUMMARY OF THE INVENTION

The object is achieved by a hydraulic arrangement for the control of an internal combustion engine with a transmission connected downstream of a start-stop-device. The arrangement includes a hydraulic energy source for hydraulic energy supply, with an energy accumulator connected downstream of the hydraulic energy source, for at least partial storing and dispensing of the hydraulic energy provided by means of the hydraulic energy source. A hydraulic control provides for controlling the automated transmission associated with the hydraulic energy source, and the energy accumulator is met in that the energy accumulator is associated with the pilot-control circuit of the hydraulic control by means of a branch. The energy accumulator can advantageously branch off hydraulic energy of the pilot-control circuit, and upon requirement make it available again to the pilot-control circuit at the same point. As a result, the pilot-control circuit can be supplied with hydraulic energy in a secured manner, also during stop phases, especially during transition from a stop phase into an operation phase of the start-stop-device in which the internal combustion engine is switched off or is just being switched off. The pilot-control circuit provided for activating the remaining hydraulic control is advantageously supplied with hydraulic energy.

In an exemplary embodiment of the hydraulic arrangement, it is provided that the energy accumulator includes a diaphragm spring accumulator. Advantageously, a diaphragm spring accumulator features very flat pressure-volume dependency. In spite of the above, it is hardly dependent upon advantageous temperature influences. Furthermore, a diaphragm spring accumulator is subject only to minor aging.

In a further exemplary embodiment of the hydraulic arrangement, it is provided that the branch features a charging pressure valve. The charging pressure valve can be connected between the pilot-control circuit and the energy accumulator, whereby the energy accumulator can be associated with the pilot-control circuit depending on need. Association can occur, for example, only for charging, and in the opposite case for relieving the energy accumulator. In the remaining operating states of the hydraulic arrangement, or rather of the hydraulic control for activating the transmission, the energy accumulator can be disconnected completely. Advantageously, no undesirable influence of the pilot-control circuit takes place through the energy accumulator.

In a further exemplary embodiment of the hydraulic arrangement it is provided that the branch is associated with an OR valve, whereby a first OR connection of the OR valve of the hydraulic energy source is connected downstream and a second OR connection of the OR valve is associated with the pilot-control circuit. The branch can, and hence the energy accumulator can, be associated advantageously by means of the OR valve, dependent upon a pressure difference either to the hydraulic energy source, for example to charge the energy accumulator, or to the pilot-control circuit, for example, for discharging the energy accumulator.

In a further exemplary embodiment of the hydraulic arrangement, it is provided that the energy accumulator includes a mechanical block. The mechanical block can advantageously impede the discharge of the energy accumulator. For a possibly necessary or desired energy withdrawal, the mechanical block can be disabled. It is possible to design the energy accumulator by means of the mechanical block such that the charging valve can be omitted.

In a further exemplary embodiment of the hydraulic arrangement, it is provided that the transmission is formed as a conical pulley continuously variable transmission. In a conical pulley continuously variable transmission a transmission ratio between the internal combustion engine and a drive train connected downstream can be selected or adjusted freely.

In a further exemplary embodiment of the hydraulic arrangement it is provided that the branch is connected downstream of a pilot pressure control valve of the pilot-control circuit. A pilot-control pressure, for example of 5 bar, of the pilot-control circuit can be adjusted by means of the pilot pressure control valve. It is possible to charge the energy accumulator with the pressure adjustable by means of the pilot pressure control valve.

### BRIEF DESCRIPTION OF THE DRAWING

Further advantages, features and details of the invention are derivable from the following description, in which exemplary embodiments are described in detail with reference to the drawing. Identical, similar, and/or functionally identical parts are provided with the same reference numerals.

The figures show:

FIG. 1 a hydraulic arrangement with a hydraulic energy source, an energy accumulator, as well as a hydraulic control for actuating an automated transmission, and

FIG. 2 a hydraulic arrangement similar to the hydraulic arrangement shown in FIG. 1, whereby in addition an OR valve is provided.

### DESCRIPTION OF THE PREFERRED EMBODIMENTS

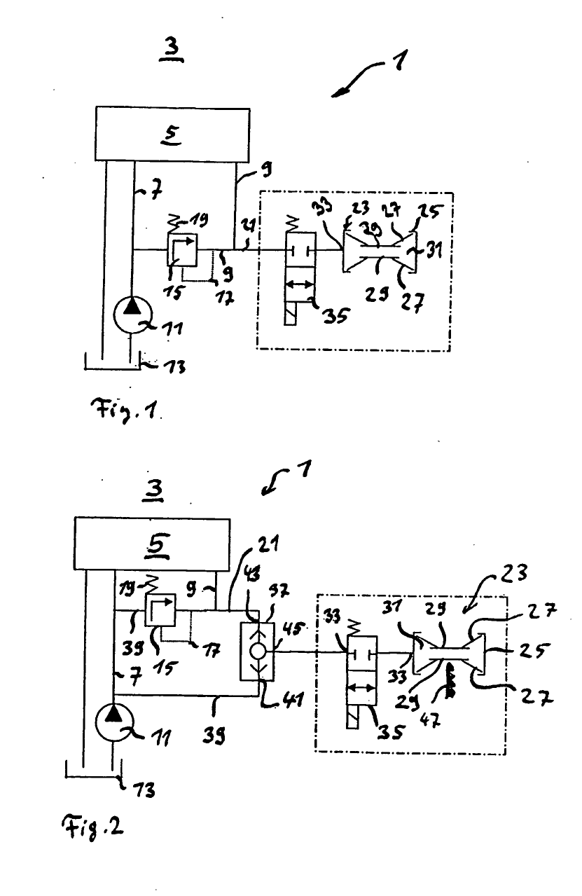

FIG. 1 shows a hydraulic arrangement 1 for the control of an internal combustion engine (not shown) that includes a start-stop-device, and a transmission connected downstream, which is represented in FIG. 1 only by the reference symbol 3. For the activation of the transmission 3, the hydraulic arrangement 1 includes a hydraulic control 5. The transmission 3 can be automatically controlled by means of the hydraulic control 5, whereby, for example, driving stages such as parking, neutral, driving, as well as a reverse gear, can be activated hydraulically. The transmission 3 can be any automated transmission, for example a stepped automatic transmission, a conical pulley continuously variable transmission, or a double clutch transmission.

For the automation, or rather activation, of the transmission 3, the hydraulic control 5 can include control valves and actuating valves—not shown in detail—as well as control pistons. The hydraulic control 5 includes a main pressure circuit 7 as well as a pilot-control circuit 9. By means of the pilot-control circuit 9 and the main pressure circuit 7, the hydraulic components of the hydraulic control 5—not shown in detail—can be supplied with hydraulic energy. At the same time, it is possible to pressurize the pilot-control circuit 9 with a pilot-control pressure, for example 5 bar, and the main pressure circuit 7 with a system pressure that usually lies above the pilot-control pressure. To produce the system pressure and/or the pilot-control pressure, the hydraulic control 5 is associated with or connected downstream of a hydraulic energy source 11. The hydraulic energy source 11 can pump a hydraulic medium, for example hydraulic oil, out of a tank 13 and raise the pressure level up to the system pressure.

The main pressure circuit 7 is connected directly downstream of the hydraulic energy source 11. The pilot-control circuit 9 is also connected downstream of the hydraulic energy source, however via a pilot pressure control valve 15. The pilot-pressure control valve 15 can be a common pressure control valve used for that purpose, with a feedback pressure recirculation line 7 and a spring 19. The pilot pressure control valve 15 reduces the system pressure provided by the hydraulic energy source 11 to the pilot pressure. The hydraulic energy source can, for example, involve a hydraulic pump driven mechanically by means of the internal combustion engine (not shown). It is also possible, however, to drive the hydraulic pump by means of an electric motor—likewise not shown. Finally, it is possible that the hydraulic energy source 11 includes a combination of a mechanical drive and an electric drive, especially a mechanically driven pump and an electrically driven pump.

The pilot-control circuit 9 is associated by means of a branch 21 with an energy accumulator 23 for storing hydraulic energy. The energy accumulator 23 is a hydraulic pressure accumulator and includes an annular housing 25. Two diaphragm springs 27 are accommodated in the housing 25. The diaphragm springs 27 respectively rest on the housing and have a U-shaped cross-section. The diaphragm springs 27 disposed oppositely are in fluid-tight contact with the housing 25, and with a spring cover 29, respectively. Appropriate sealing means are not shown. A pressure chamber 31 is surrounded by the housing 25, the diaphragm springs 27, and the spring covers 29. The pressure chamber 31 can be enlarged against the forces of springs 27 for storing hydraulic energy, and in the reversed case it can be decreased again by releasing hydraulic energy. A corresponding energy accumulation takes place by means of the diaphragm spring 27.

The energy accumulator 23 includes a connection 33 to which the pressure chamber 31 is associated. The connection 33 of the energy accumulator 23 is assigned to charging valve 35. The charging valve 35 can be provided, for example, as an electrically actuated switching valve. The branch 21 can either be connected to or disconnected from the connection 33 of the energy accumulator by means of the charging valve. The energy accumulator 23 can be advantageously associated by means of the charging valve 35 to the pilot-control circuit 9 only for charging or discharging purposes. In operating states of the hydraulic control 5, in which no additional energy supply is necessary from the energy accumulator 23, the energy accumulator 23 can be disconnected. A corresponding position of the charging valve 35 is shown in FIG. 1.

FIG. 2 shows a further hydraulic arrangement 1 that is similar in design to the hydraulic arrangement 1 shown in FIG. 1. In the following passage, only the differences are explained further.

In contrast to the representation shown in FIG. 1, the hydraulic arrangement shown in FIG. 2 includes an OR valve 37 that is connected in a parallel branch 39 to the main pressure circuit 7 that also includes the pilot pressure control valve 15.

The OR valve 37 includes a first OR connection 41 and a second OR connection 43, as well as a middle connection 45. The middle connection 45 is associated with the connection 33 of the charging valve 35. The first OR connection 41 of the OR valve 37 is connected downstream of the hydraulic energy source 11. The second OR connection 43 of the OR valve 37 is connected to the branch 21 and is associated therewith to the pilot-control circuit 9 and the pilot pressure control valve 15.

It is possible advantageously to dispense with high additional flows during a start process of the internal combustion engine (not shown). Advantageously, by the energy accumulator 23, especially during the start process, hydraulic energy for the hydraulic control 5 can be supplied, especially to the pilot-control circuit 9. The energy accumulator 23, including the diaphragm springs 27 and the pressure chamber 31, forms a so-called diaphragm spring accumulator that advantageously features a flat pressure-volume dependency, with hardly any temperature influences and more-or-less no change of the accumulator capacity of the pressure chamber 31 over its service life.

The flat pressure-volume dependency of the energy accumulator 23 permits it, at the points of the hydraulic control 5 at which during the start process of the internal combustion engine a deficiency of supply can occur, to store hydraulic energy during normal operation by means of the diaphragm springs 27 of the energy accumulator 23, in order to again feed it at that point in the event of demand. At that time, the energy accumulator 23 is advantageously associated with the pilot-control circuit 9 by means of the branch 21, namely at a position connected downstream of the pilot pressure control valve 15. That position, behind the pilot-control pressure valve 15, is especially suited for a so-called conical pulley continuously variable transmission (CVT). Alternatively, also other empty conditions are conceivable, especially in stepped automatic transmissions or double clutch transmissions. Via the electrically controllable charging valve 35, the energy accumulator 23 can be sealingly disconnected from the remaining hydraulic arrangement 1. Solely for charging and discharging purposes, the charging valve 35 can be advantageously addressed briefly so that it opens.

The charging valve 35 can preferably involve a spring-loaded seat valve. Alternatively, also conceivable is an embodiment with a sealed, so-called slide valve. Further conceivable is that the energy accumulator 23 in a pressurized, thus a charged state, is mechanically blocked in order to ensure that the accumulated energy in the steel of the diaphragm springs cannot be unintentionally decreased via a possibly existing leakage of the charging valve 35.

In FIG. 2, a block 47 of the energy accumulator 23 is schematically outlined. By means of the block 47, a reduction of the pressure chamber 31 otherwise taking place can be blocked by spring forces of the diaphragm springs 27, so that unintentional escape of energy out of the energy accumulator 23 is securely preventable. In the case of a desired energy withdrawal, the block 47 can be unlocked so that the energy accumulator 23 can dispense hydraulic energy in the pilot-control circuit 9. For that case it is conceivable to forgo the charging valve 35, thus to omit it completely, especially if it is ensured that drainage of the energy accumulator 23 via a corresponding line is provided for. Such mechanical blocking systems are disclosed in DE 43 23 133 A1 by the same applicant, and can find application in analogy also for the energy accumulators shown in FIGS. 1 and 2. DE 43 23 133 A1, especially FIGS. 1 and 2, as well as the pertinent description, are made with reference to the contents of this application.

Should it become necessary to charge the energy accumulator 23 with a higher-pressure level than the pressure level of the connected consumer during the start process of the internal combustion engine, that is also possible in accordance with the representation in FIG. 2. Advantageously, that can occur by means of the OR valve 37 that is connected in parallel to the main pressure circuit 7 and is connected downstream of the hydraulic energy source. The OR valve 37 is connected between the connection 33 of the charging valve 35 and the branch 21, thus in a discharge line associated with the energy accumulator 23. Charging of the energy accumulator 23 can take place with an opened charging valve 35 via the first OR connection 41 or the second OR connection 43, and thus, depending upon which one of the connections 41, 43 is exposed to the higher pressure. In the case of the first OR connection 41, the higher system pressure can be involved. A volume flow for discharging the energy accumulator 23 can be fed via the OR valve 37 to the pilot-control circuit 9.

1. A hydraulic arrangement for the control of a transmission connected downstream of an internal combustion engine having a start-stop-device, said hydraulic arrangement comprising:
a hydraulic energy source for providing hydraulic energy,
an energy accumulator connected downstream of the hydraulic energy source for storing and dispensing hydraulic energy that is provided by the hydraulic energy source,
a hydraulic control for actuating the automated transmission associated with the hydraulic energy source and energy accumulator,
wherein the energy accumulator is connected by a branch line to a pilot-control circuit of the hydraulic control.

2. The hydraulic arrangement according to claim 1, wherein the energy accumulator includes a housing containing a diaphragm spring.

3. The hydraulic arrangement according to claim 1, wherein the branch line includes a charging valve.

4. The hydraulic arrangement according to claim 1, wherein the branch line is connected with an OR valve, wherein the OR valve includes a first OR connection connected downstream of the hydraulic energy source and a second OR connection connected with the pilot-control circuit.

5. The hydraulic arrangement according to claim 1, wherein the energy accumulator includes a mechanical block.

6. The hydraulic arrangement according to claim 1, wherein the branch line is connected downstream of a pilot pressure control valve of the pilot-control circuit.

7. The hydraulic arrangement according to claim 1, wherein the transmission is a conical pulley continuously variable transmission.
